(19) United States
(12) Patent Application Publication
(10) Pub. No.: US 2012/0035038 A1
(43) Pub. Date: Feb. 9, 2012

(54) DUNNAGE CONVERSION SYSTEM AND METHOD WITH STOCK MATERIAL SPLICING

(75) Inventors: Holly J. Lembach, Sagamore Hills, OH (US); William S. Chapnick, Solon, OH (US); David M. Gabrielsen, Chagrin Falls, OH (US)

(73) Assignee: RANPAK CORP., Concord Township, OH (US)

(21) Appl. No.: 12/674,996

(22) PCT Filed: Aug. 22, 2008
(86) PCT No.: PCT/US08/74022

§ 371 Date: Jul. 13, 2011

Related U.S. Application Data
(60) Provisional application No. 60/957,859, filed on Aug. 24, 2007.
(60) Provisional application No. 60/957,863, filed on Aug. 24, 2007.

(51) Int. Cl. B31F 1/00

(52) U.S. Cl. 493/381

(57) ABSTRACT

A method that includes the steps of (i) attaching a leading portion of a supply of stock material to a trailing portion of a preceding supply of stock material by means of a mechanical fastener, an electromagnetic field, electrostatic charges, or an activatable bonding agent, and (ii) converting the stock material into a relatively less dense dunnage product. The attaching step may include (a) embossing, punching, stitching, stapling, riveting, clipping, snapping, buttoning, attaching with male and female interlocking devices or hook-and-loop fasteners, (b) integrating one or more elements into the stock material to provide a stock material with magnetic or magnetizable material in the leading or trailing portion, (c) imparting opposing and attractive magnetic charges in respective leading and trailing portions, (d) inducing an electrostatic charge or a magnetic field in at least one of the leading and trailing portions, and/or (e) activating a bonding agent.

We claim the benefit of U.S. Provisional Patent Application No. 60/957,859 filed Aug. 24, 2007 and U.S. Provisional Patent Application No. 60/957,863 filed Aug. 24, 2007, both of which are hereby incorporated herein by reference.

### FIELD OF THE INVENTION

The present invention relates to a system and method for converting sheet stock material into a dunnage product and, more particularly, to a system and method that facilitate splicing a new supply of stock material to an almost-spent supply of stock material.

### BACKGROUND

Dunnage conversion machines convert a stock material into a dunnage product that is used to package products for shipment. The stock material is often supplied in the form of a roll from which the stock material is payed off for conversion by the machine into the dunnage product. When the roll is spent, a new roll is loaded in place of the spent roll, and the leading end of the stock material from the new roll is fed into the machine. One way to feed stock material from the new supply into the machine is to splice the leading end of the stock material from the new supply to the trailing end of the stock material from the almost-spent supply. Once spliced, when the machine is operated again the trailing end pulls the leading end through the machine.

Several techniques have been used to splice a new supply of stock material to an almost-spent supply of stock material. One way was to use several strips of tape extending across the joint between the leading end of the new or succeeding supply and the trailing end of the almost-spent or preceding supply.

Another splicing technique has been to spray a liquid adhesive on the trailing end of the almost-spent supply and then pressing the leading end of the new supply to the adhesive-covered trailing end. When the trailing end and the leading end were overlapped, the sprayed-on adhesive bonded them together.

Yet another splicing technique provided a stock material with a pre-applied pressure-sensitive adhesive on the leading end and/or the trailing end of the stock material. When a supply of stock material was nearly depleted, a release liner was removed to expose one or more adhesive strips before the leading and trailing ends were pressed together to create a bond between them. For further details, see commonly-owned U.S. Pat. No. 6,756,096, which is hereby incorporated herein by reference.

Additionally, to facilitate splicing some conversion machines have been provided with a splicing plate on which the trailing end is held while the leading end is spliced thereto.

### SUMMARY

The present inventors recognize that prior splicing methods were not without drawbacks, however. For example, if the almost-spent and new supplies of stock material are to be spliced by taping, then the machine operator must have a supply of adhesive tape handy. Otherwise, delays in productivity may ensue. Also, the prior art taping process was somewhat tedious, particularly when multi-ply stock rolls were used, as normally was the case. Additionally, if incorrectly applied, the tape could dislodge and jam the machine or otherwise affect the conversion of the stock material.

With regard to the spray adhesive, the adhesive may be oversprayed on the stock material or on parts within or in close proximity to the conversion machine. If the adhesive is sprayed on unintended areas of the stock material then the stock material may jam the conversion machine or otherwise deleteriously affect the quality of the dunnage product. Overspray on parts of the machine may affect the operation of those parts, particularly if the parts require movement.

Moreover, with regard to the release-liner-covered, pre-applied pressure-sensitive adhesive, the release liner generally must be disposed of, incurring disposal costs and additional effort by the operator to keep the packaging area clear of discarded release liners. The operator also must supply sufficient pressure across the adhesive to activate it, or the bond will not be strong enough to hold the leading and trailing ends together.

To further improve the splicing process, an exemplary dunnage conversion system provided in accordance with the present invention includes (i) a charging device for imparting opposing electrostatic charges to at least one of a leading portion of a succeeding supply of stock material or a trailing portion of a preceding supply of stock material to bond the leading and trailing portions together, and (ii) a conversion mechanism downstream of the charging device for converting the stock material into a relatively less dense dunnage product.

The present invention also provides a method of producing a dunnage product comprising the steps of (i) attaching a leading portion of a succeeding supply of stock material to a trailing portion of a preceding supply of stock material by means of an electromagnetic field or electrostatic charges, and (ii) converting the stock material into a relatively less dense dunnage product.

A method for producing a stock material for conversion into a dunnage product includes the step of providing a magnetic material at a leading or trailing portion of a length of sheet stock material.

Another dunnage conversion system provided in accordance with the present invention includes (i) a device for activating a bonding agent on at least one of a leading portion of a succeeding supply of sheet stock material or a trailing portion of a preceding supply of sheet stock material to bond the leading and trailing portions together, and (ii) a conversion mechanism downstream of the activating device for converting the stock material into a relatively less dense dunnage product.

Another method for preparing a stock material for conversion into a dunnage product includes the steps of (i) applying an activatable bonding agent to at least one of a leading portion of a succeeding supply of sheet stock material and a trailing portion of a preceding supply of sheet stock material, and (ii) either rolling the sheet stock material into a roll or fan-folding the sheet stock material to form a stack.

Another method for producing a dunnage product includes the steps of: (i) providing a stock material with a bonding agent on at least a leading portion of a succeeding supply of stock material, (ii) activating the bonding agent to bond the leading portion to a trailing portion of a preceding supply of stock material, and (iii) converting the stock material into a relatively less dense dunnage product.

Further, the present invention provides a dunnage conversion method that includes the following steps: (i) providing stock material from a first supply having a first part of a cohesive on a trailing portion, (ii) converting the stock material from the first supply into a dunnage product, (iii) providing stock material from a second supply having a second part of a cohesive on a leading portion, and (iv) bonding the leading and trailing portions together.

Another exemplary dunnage conversion system provided in accordance with the present invention includes (i) a fastening mechanism for mechanically fastening a leading portion of a succeeding supply of stock material to a trailing portion of a preceding supply of stock material, and (ii) a conversion mechanism downstream of the fastening mechanism for converting the stock material into a relatively less dense dunnage product.

The present invention also provides a method that includes the steps of (i) mechanically fastening a leading portion of a succeeding supply of stock material to a trailing portion of a preceding supply of stock material, and (ii) converting the stock material into a relatively less dense dunnage product.

Additionally, the present invention provides a supply of stock material for use in a dunnage converter for conversion into relatively less dense dunnage product. The supply includes a length of stock material having opposite leading and trailing end portions, and mateable fastening elements respectively attached to the leading and trailing portions of the stock material. The mateable fastening elements can be attached to respective fastening elements of a succeeding or preceding supply of stock material before passage through the dunnage converter.

The foregoing and other features of the invention are hereinafter fully described and particularly pointed out in the claims, the following description and annexed drawings setting forth in detail a certain illustrative embodiment of the invention, this embodiment being indicative, however, of but one of the various ways in which the principles of the invention may be employed.

### BRIEF DESCRIPTION OF THE DRAWINGS

FIG. 1 is a schematic diagram of an exemplary dunnage conversion system provided in accordance with the present invention.

FIGS. 2-4 are schematic views of various types of supply of sheet stock material for use in the system provided by the present invention.

FIGS. 5-7 are schematic views of splices provided in accordance with the present invention that illustrate various types of splicing techniques for fastening the leading end of a succeeding supply of stock material to a trailing end of a preceding supply of stock material.

FIG. 8 is an exemplary supply of stock material provided in accordance with the present invention with a pre-applied bonding agent.

FIGS. 9-23 are schematic views of splices provided in accordance with the present invention that illustrate various types of splicing techniques for fastening the leading end of a succeeding supply of stock material to a trailing end of a preceding supply of stock material.

FIG. 24 is an exemplary supply of stock material provided in accordance with the present invention with pre-applied fasteners.

FIGS. 25-27 are side views of various types of dunnage conversion machines and their internal components, for use in the system provided by the present invention.

### DETAILED DESCRIPTION

The present invention provides a dunnage conversion system, method, and supply of stock material that facilitate splicing a leading portion of a new or succeeding supply of stock material to a trailing portion of a preceding or almost-spent supply of stock material for conversion into a dunnage product.

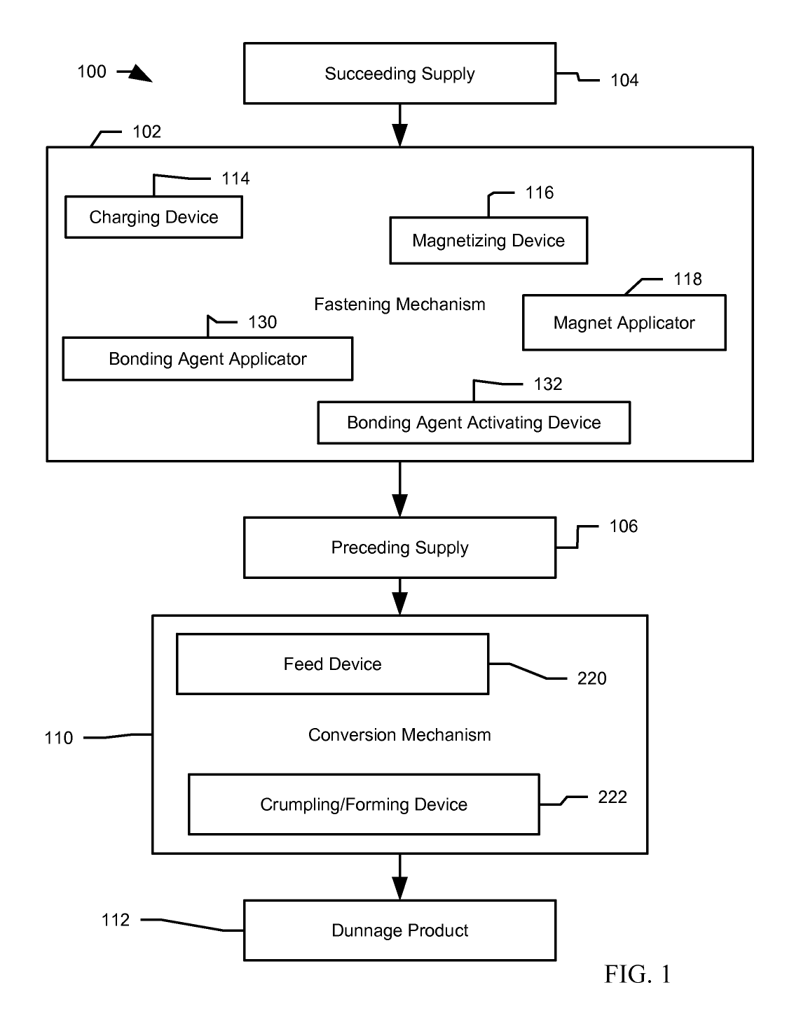

Referring now to the drawings in detail, and initially to FIG. 1, an exemplary dunnage conversion system 100 provided in accordance with the present invention includes a fastening mechanism 102 for fastening a leading portion of a succeeding supply 104 of stock material to a trailing portion of a preceding supply 106 of stock material, and a conversion mechanism 110 downstream of the fastening mechanism for converting the stock material into a relatively thicker and less dense dunnage product 112.

In operation, the present invention provides a method comprising the steps of fastening a leading portion of a succeeding supply of stock material to a trailing portion of a preceding supply of stock material, and converting the stock material into a relatively thicker and less dense dunnage product. The leading and trailing end portions generally are joined with a lap splice created by overlapping leading and trailing portions of respective supplies of stock material.

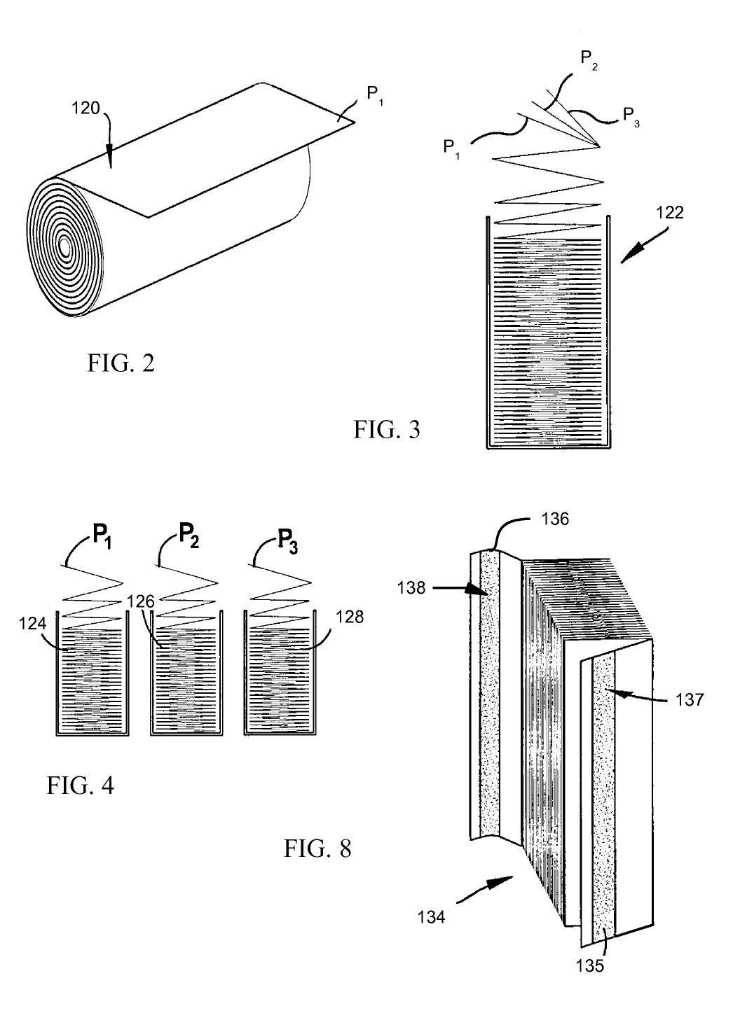

The stock material has a length dimension and generally includes a sheet stock material, several examples of which are shown in FIGS. 2-4. The supply of stock material can be provided in the form of a roll 120 (FIG. 2) or in the form of fan-folded stack 122 (FIG. 3). In a fan-folded stack 122, the sheet stock material has a series of alternating folds that form a sequence of rectangular pages piled accordion-style one on top of another. Whether the supply is in roll or fan-folded form, either single-ply or multi-ply sheet material can be used. A single-ply roll 120 of stock material is shown in FIG. 2, while a multi-ply stack 122 is shown in FIG. 3 with three plies P₁, P₂, and P₃. Alternatively, a multi-ply stock material may be supplied from multiple single-ply rolls or the stacks 124, 126 and 128 shown in FIG. 4, dispensing plies P₁, P₂, and P₃, respectively.

In a roll of stock material, the stock material can be drawn from the outer surface of the roll, typically allowing the roll to rotate or turn as the stock material is drawn therefrom. Alternatively, the stock material can be drawn from the center of the roll.

Kraft paper is an exemplary sheet stock material. Other stock materials include printed paper, bleached paper, newsprint, recycled paper, plastic, and combinations thereof, for example. The stock material may include different weights or thicknesses, such as thirty- or fifty-pound kraft paper, or combinations thereof.

In operation, one exemplary method for producing a dunnage product includes the steps of (i) attaching a leading portion of a succeeding supply of stock material to a trailing portion of a preceding supply of stock material by means of an electromagnetic field or electrostatic charges, and (ii) converting the stock material into a relatively less dense dunnage product. The attaching step may include (a) integrating one or more elements into the stock material to provide a stock material with magnetic or magnetizable material in the leading or trailing portion, (b) imparting opposing and attractive magnetic charges in respective leading and trailing portions so that they will hold together, and/or (c) inducing an electrostatic charge or a magnetic field in at least one of the leading and trailing portions of the stock material.

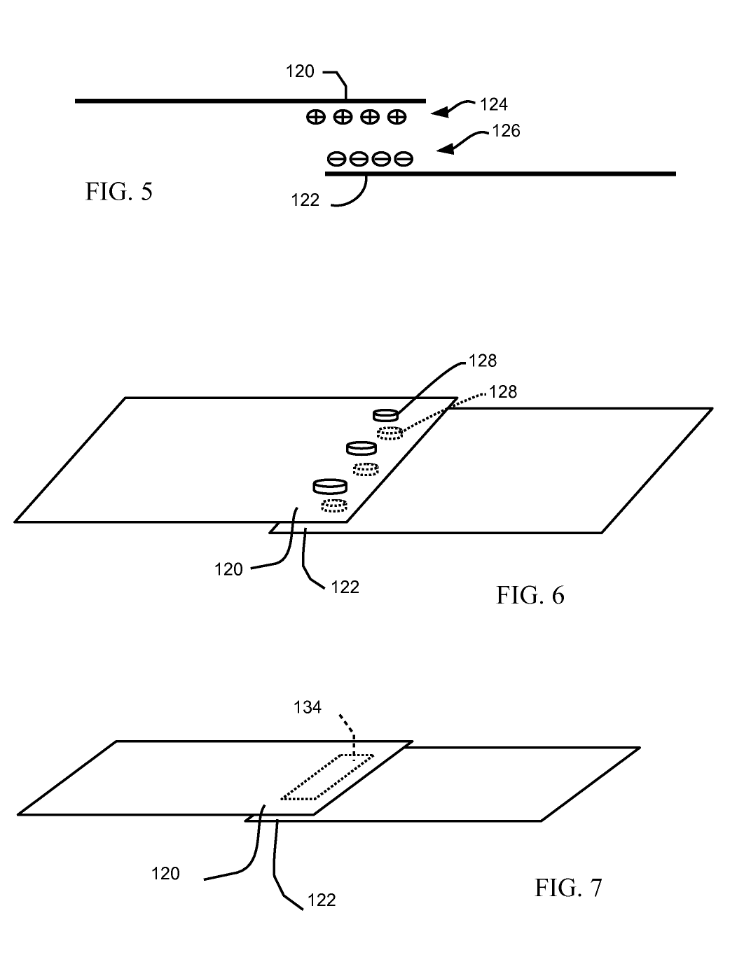

Accordingly, an exemplary fastening mechanism 102 of FIG. 1 includes a charging device 114 for imparting opposing electrostatic charges to at least one of the leading and trailing portions to bond the leading and trailing portions together, or a magnetizing device 116 for inducing a magnetic field in at least one of the leading and trailing portions whereby attractive magnetic fields will bond the leading and trailing portions together. A charging device 114 may include a belt or roller that moves relative to the stock material being drawn over it. A magnetizing device typically includes a permanent magnet or an electromagnet. Additionally or alternatively, the fastening mechanism 102 may include a magnet applicator 118 for applying magnets or a magnetizable material to the leading and/or trailing portions of the stock material. A magnetizable material typically includes a magnetizable metal, such as iron, in fiber, thread, strip, paint, or button form. Examples are shown in FIGS. 5 and 6.

In FIG. 5, opposing electrostatic charges, represented by the circled plus and minus signs 124 and 126, on the leading and trailing portions 120 and 122 attract and hold the leading and trailing portions together. An electrostatic charging device may include a bar of material over which the stock material is drawn, whereby the material properties lead to the production of a static charge, or it may include an electrified element by which the stock material is drawn to induce a static charge in the stock material. The type of charging device and whether one or both of the leading and/or trailing portions have to be actively charged will depend upon the type of stock material.

In FIG. 6, magnets or magnetizable buttons or disks 128 have been applied to opposing sides of the leading and trailing portions 120 and 122 to hold the leading and trailing portions together therebetween. Alternatively, the magnets 128 may be secured to facing surfaces of the leading and trailing portions 120 and 122 to hold the leading and trailing portions together. Depending on the conversion process, after the stock material passes through the conversion mechanism 110 (FIG. 1), the magnets may be recoverable and reusable.

Instead of or in addition to the electrostatic charges or magnetic fields, the stock material may be provided with an activatable bonding agent applied to one or both of the leading and trailing portions. Suitable bonding agents include a cohesive material, which only bonds with the same or a complimentary cohesive material; a two-part epoxy or other two-part adhesive; an ultraviolet- or infrared-curable adhesive, a friction or heat activatable adhesive, etc.

The bonding agent must be activated to bond the leading and trailing portions 120 and 122 together, as shown in FIG. 7. Accordingly, an exemplary method for preparing a stock material for conversion into a dunnage product includes the steps of: (i) applying an activatable bonding agent to at least one of a leading portion of a succeeding supply of sheet stock material and a trailing portion of a preceding supply of sheet stock material via a bonding agent applicator 130 (FIG. 1), for example, and (ii) either rolling the sheet stock material into a roll or fan-folding the sheet stock material to form a stack. A bonding agent applicator may include a sprayer, roller, or brush for a liquid bonding agent, for example.

Thus the dunnage conversion system 100 (FIG. 1) may include (i) a device 132 (FIG. 1) for activating a bonding agent on at least one of the leading portion 120 of a succeeding supply of sheet stock material or the trailing portion 122 of a preceding supply of sheet stock material to bond the leading and trailing portions together. The conversion mechanism 110 is downstream of the activating device 132 to convert the bonded leading and trailing portions into a relatively thicker and less dense dunnage product.

An exemplary method for producing a dunnage product then includes the steps of: (i) providing a stock material with a bonding agent on at least one of a leading portion of a succeeding supply of stock material and a trailing portion of a preceding supply of stock material, (ii) activating the bonding agent to bond the leading portion to the trailing portion, and (iii) converting the stock material into a relatively thicker and less dense dunnage product. The activating step may include applying at least one of heat, radiation, vibrations, or an electrical potential to the bonding agent.

With reference to FIG. 8, an exemplary supply 134 of sheet stock material includes a length of stock material having opposite end portions 135 and 136, and strips of a bonding agent 137 and 138 attached to the end portions of the stock material. The supply 134 is not limited to the illustrated single-ply fan-folded stack, but may include multiple plies and/or a roll form, as previously described.

For a cohesive bonding agent, since the cohesive is pre-applied, the leading portion of any succeeding supply of stock material may be readily spliced to the trailing portion of a preceding supply of stock material by placing the leading and trailing portions over one another. Cohesive generally will not bond to anything but another cohesive-coated surface. Accordingly, to activate the cohesive two cohesive portions of the stock material must be brought together to form a bond. The activating step in this example includes bringing cohesive portions of the leading and trailing portions together so that they are activated and will bond the leading and trailing portions together.

A related method for producing a dunnage product includes the steps of: (i) providing stock material from a first supply having a first part of a cohesive on at least a trailing portion, (ii) converting the stock material from the first supply into a dunnage product, (iii) providing stock material from a second supply having a second part of a cohesive on a leading portion, and (iv) bonding the leading and trailing portions together.

In summary, the present invention provides a method for producing a dunnage product includes the steps of (i) attaching a leading portion of a succeeding supply of stock material to a trailing portion of a preceding supply of stock material by means of an electromagnetic field, electrostatic charges, or an activatable bonding agent, and (ii) converting the stock material into a relatively less dense dunnage product. The attaching step may include (a) integrating one or more elements into the stock material to provide a stock material with magnetic or magnetizable material in the leading or trailing portion, (b) imparting opposing and attractive magnetic charges in respective leading and trailing portions so that they will hold together, (c) inducing an electrostatic charge or a magnetic field in at least one of the leading and trailing portions of the stock material, and/or (d) activating the bonding agent.

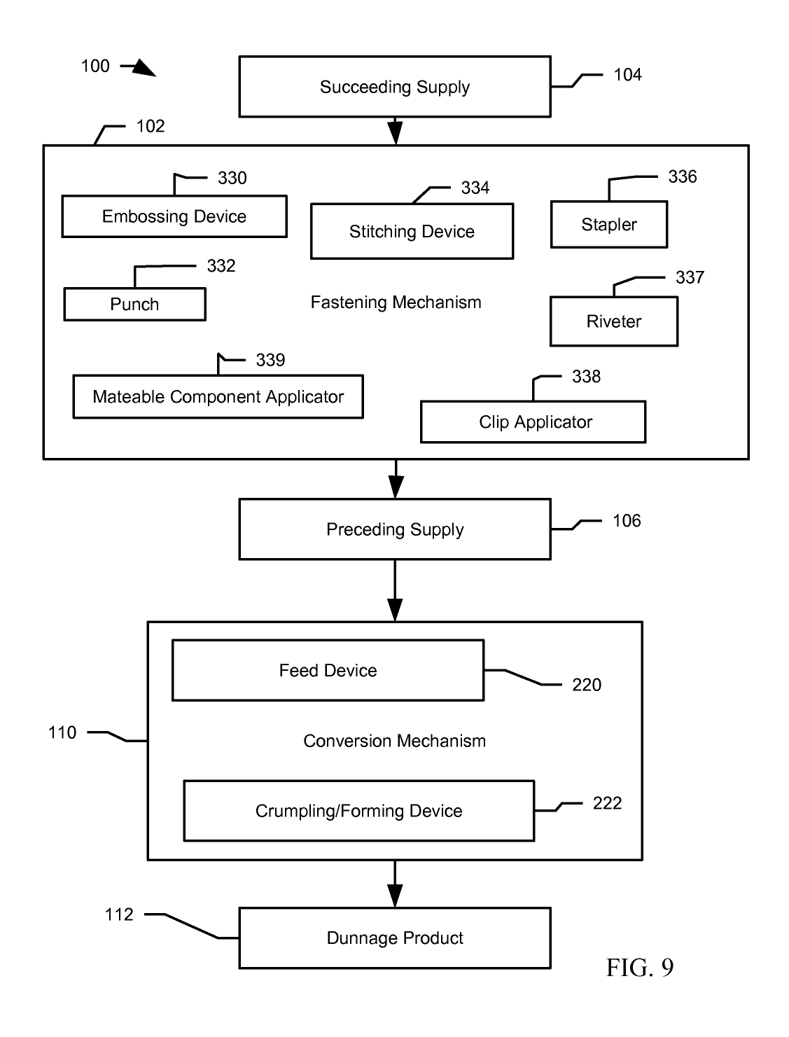

Alternatively or additionally, various other types of fasteners, including interlocking elements, connecting components and/or fastening elements, may be used to mechanically fasten or connect the succeeding and preceding supplies of stock material. To that end, different types of fastening devices may be employed. FIG. 9 is identical to FIG. 1 except in the additional alternatives identified for the fastening mechanism 102. See the description of FIG. 1 for details about the other elements of FIG. 9.

As shown in FIG. 9, the fastening mechanism 102 may include one or more of a punch 330 or an embossing mechanism 332, for example. An exemplary punch 330 may include two or more opposing segmented gears, such as those disclosed in U.S. Pat. No. 6,035,613, which is hereby incorporated herein by reference, for forming tabs in the stock material as the stock material passes between the gears. Alternatively, the punch may operate by pressing an anvil against a die when the leading and trailing portions are interposed therebetween.

An exemplary embossing mechanism 332 may include two or more opposing wheels with mating protrusions and recesses that locally deform the stock material fed therebetween. The fastening mechanism 102 is not limited to these devices, however, and may include other means for forming interlocking elements from the leading and trailing portions that mechanically interlock the leading and trailing portions.

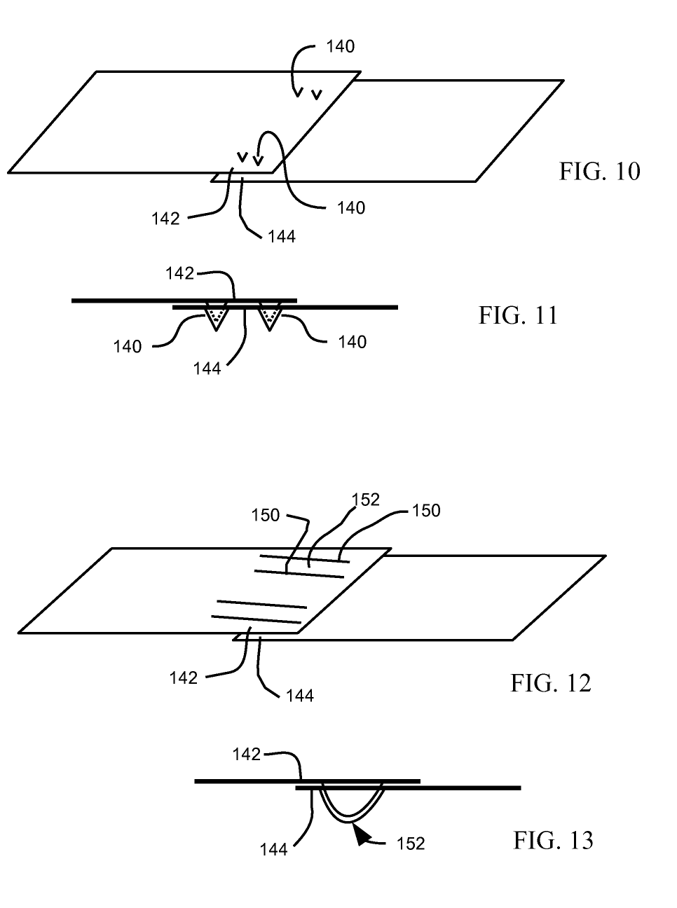

For example, as shown in FIGS. 10 and 11, embossings 140 in the sheet stock material locally deform overlaid leading and trailing portions 142 and 144 out of their generally planar shape sufficiently to hold the leading and trailing portions 142 and 144 together as they are pulled into the conversion mechanism 110 (FIG. 9). The embossings may extend continuously across the stock material or lie in one or more discrete locations. Alternatively, as shown in FIGS. 12 and 13, a pair of parallel slits 150 may be cut in the stock material and the stock material therebetween pushed out of the plane of the bulk of the stock material to form a tab 152. A single tab may be formed or multiple tabs may be formed in the overlapping leading and trailing portions 142 and 144. In both cases, friction between the leading and trailing portions 142 and 144 is increased, thereby allowing the old or preceding supply of stock material to pull the new or succeeding supply into the conversion mechanism 110 (FIG. 9).

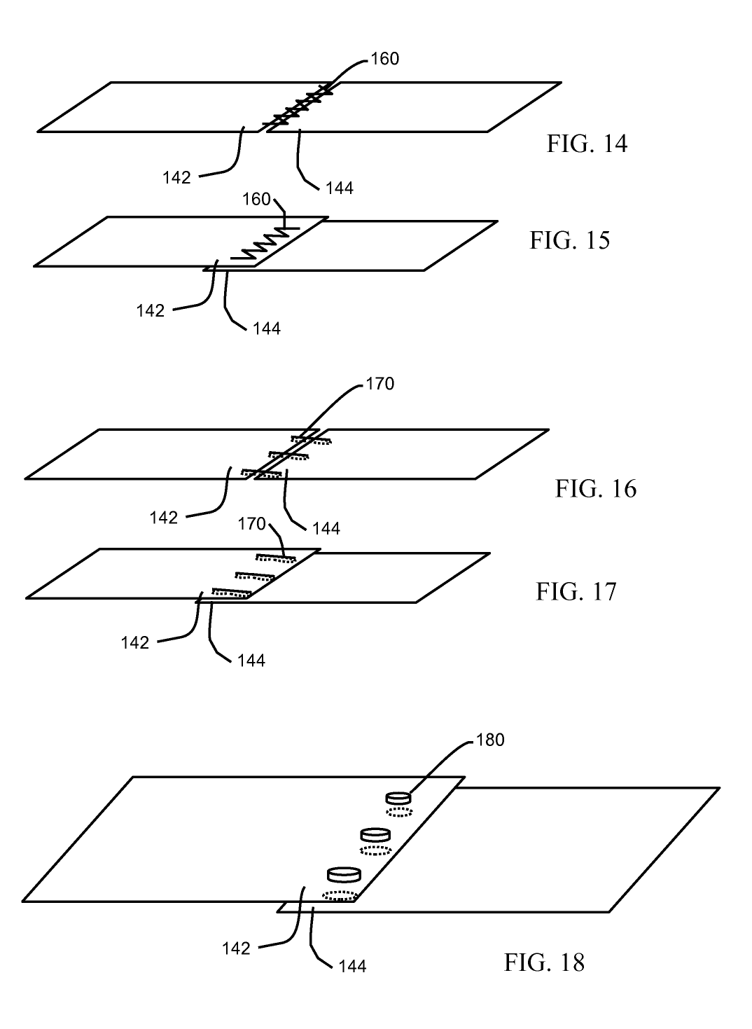

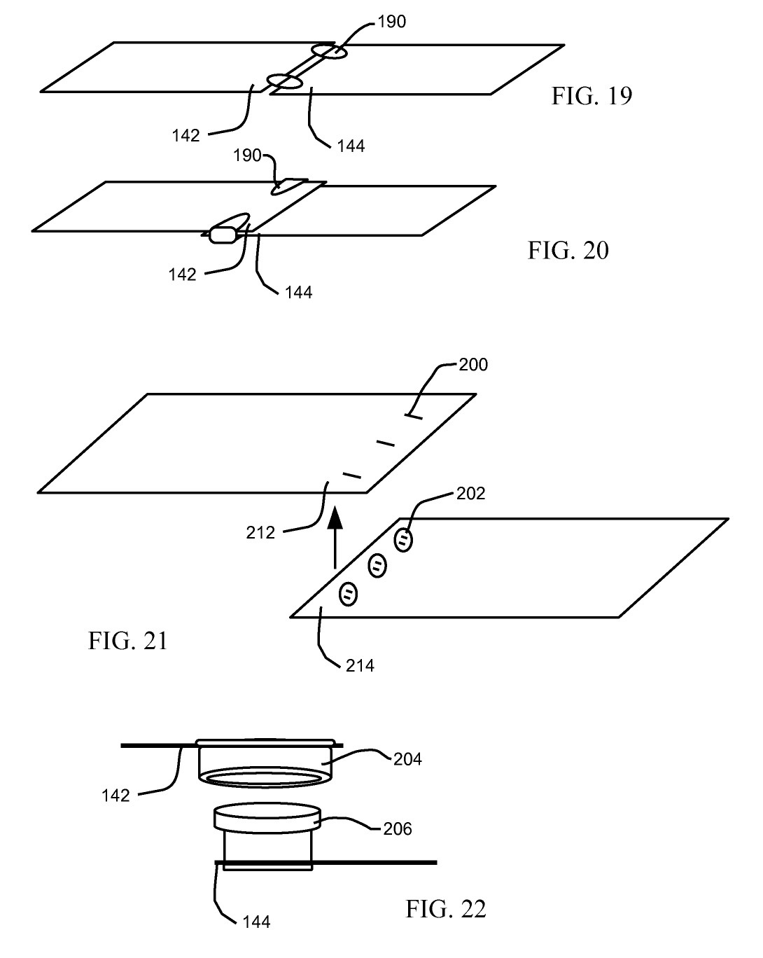

Additionally or alternatively, the fastening mechanism 102 (FIG. 9) may apply one or more connecting components to the leading portion 142 and the trailing portion 144 to effect a connection therebetween. Such connecting components may include one or more of stitches 160 (FIGS. 14 and 15), staples 170 (FIGS. 16 and 17), rivets 180 (FIG. 18), or clips 190 (FIGS. 19 and 20).

Accordingly, the fastening mechanism 102 may include one or more of a stitching device 334, a stapler 336, a riveter 337, or a clip applicator 338. In the case of stitches 160, staples 170, and clips 190, the leading and trailing portions 142 and 144 may be arranged in either an abutting relationship (FIGS. 14, 16, and 19) or an overlapping relationship (FIGS. 15, 17, and 20).

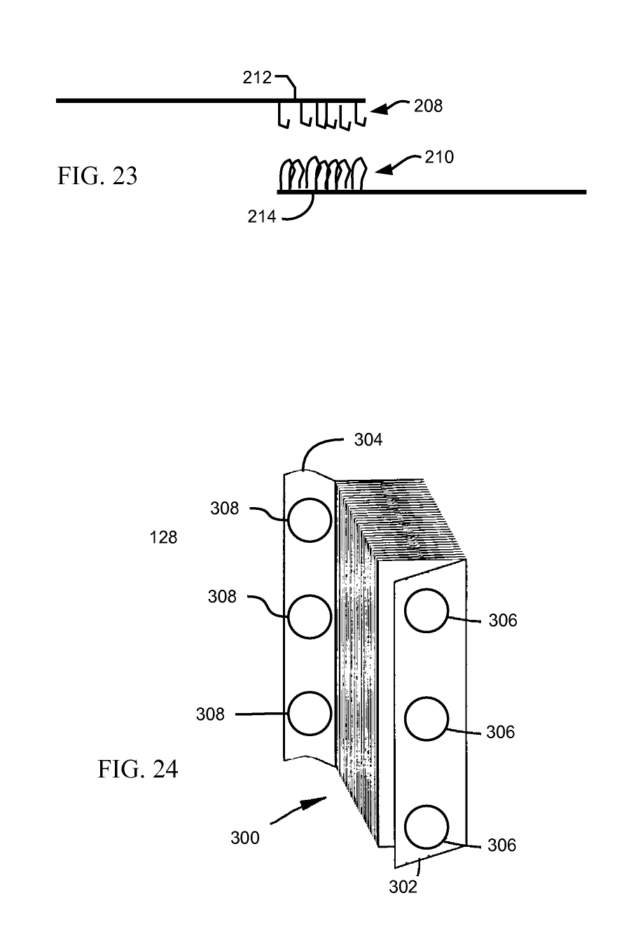

Another type of fastening mechanism applies at least one of at least two mateable fastening elements 200 and 202 (FIG. 21), 204 and 206 (FIG. 22), or 208 and 210 (FIG. 23) to at least one of the leading and the trailing end portions 212 and 214. Suitable mateable fastening elements include at least one of: hook-and-loop-fasteners 208 and 210 (FIG. 23), male and female interlocking devices, such as snap elements 204 and 206 (FIG. 22) or buttons 202 and holes 200 (FIG. 21). Thus the fastening mechanism 102 (FIG. 9) may include a mateable component applicator 339 (FIG. 9) or other device that applies respective components to leading and trailing portions of the stock material to hold them together.

In operation, the present invention provides a method comprising the steps of mechanically fastening a leading portion of a succeeding supply of stock material to a trailing portion of a preceding supply of stock material, and converting the stock material into a relatively less dense dunnage product.

Fastening typically includes abutting or overlapping (as in FIGS. 14 and 15) the leading and trailing portions. Mechanically fastening further includes one or more of (i) providing interface elements that mechanically interlock the leading and trailing portions, (ii) punching or embossing, or (iii) applying one or more connecting components to the leading and trailing portions to effect a connection therebetween. Consequently, the fastening step may include one or more of stitching, stapling, riveting, or clipping the leading and trailing portions to effect a connection therebetween.

The present invention also provides a supply of stock material for use in a dunnage converter for conversion into relatively thicker and less dense dunnage product. An exemplary supply 300 is shown in FIG. 24. The supply 300 includes a length of stock material having opposite leading and trailing end portions 302 and 304, and mateable fastening elements 306 and 308, respectively, attached to the leading and trailing portions of the stock material. The mateable fastening elements 306 and 308 can be attached to respective fastening elements of a succeeding or preceding supply of stock material before passage through the conversion mechanism 110 (FIG. 9). The supply is not limited to the illustrated single-ply fan-folded stack, but may include multiple plies and/or a roll form, as previously described. The mateable fastening elements may include any of the buttons 202 (FIG. 21), snaps 204 and 206 (FIG. 22), and hook-and-loop fasteners 208 and 210 (FIG. 23) described above, or combinations thereof. Moreover, while the illustrated supply includes three mateable fastening elements 306 and 308 on each of the leading and trailing portions 302 and 304, respectively, more or fewer fastening elements may be provided as desired or as required to obtain sufficient holding power for the particular application.

Naturally, in considering the type of fastener, the number of fasteners, and the location of the fasteners used in splicing, consideration should be given to its compatibility with the type of conversion mechanism employed. Not all fasteners and fastener locations are suitable for all types of conversion mechanisms.

To splice the succeeding supply of stock material to an almost-spent preceding supply of stock material (not shown), the leading end of the ply of sheet material from a succeeding supply, along with the bonding agent thereon, is removed (e.g., unwound or unfolded) from the supply and then spliced to the trailing end of a ply of the almost-spent supply of stock material.

In the conversion process, many dunnage conversion mechanisms pull the sheet stock material from the supply, and this pulling action tends to create tension in the stock material. Consequently, the splicing technique employed generally should bond the leading and trailing end portions together with sufficient holding power and shear strength between the leading and trailing portions to hold them together when subjected to a longitudinal pulling force (at least until the leading portion of the new supply has been engaged by the conversion mechanism 110 (FIG. 1)).

An exemplary conversion mechanism 110 includes a feed device 220 (FIG. 1) that draws the stock material through a crumpling device and/or forming device 222 (FIG. 1). The conversion mechanism 110 may be embodied in a dunnage conversion machine or a portion thereof.

The dunnage conversion machine 230 shown in FIG. 25, for example, includes a conversion assembly having a forming device 234 and a feed device 236 that feeds the stock material through the forming device 234. The forming device turns lateral edges of the sheet stock material inwardly and crumples the stock material as it is drawn therethrough. The feed device also connects overlapping layers of stock material to form a dunnage product 238 with lateral pillow portions spaced on either side of a connecting portion. In the connecting portion, the layers of stock material are held together, and therefore the connecting portion helps to maintain the shape of the dunnage product as it is manipulated.

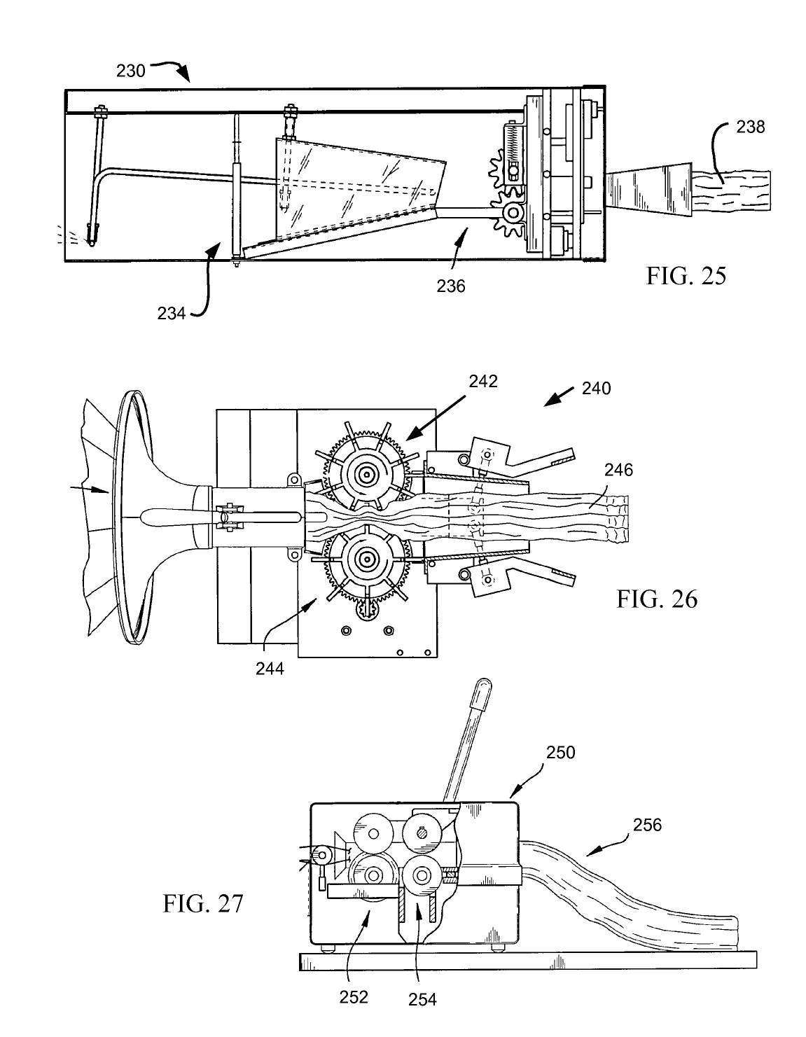

Another dunnage conversion machine 240 is shown in FIG. 26. In this dunnage conversion machine a pair of grippers 242 and 244 form a combined feed device and crumpling device to laterally and transversely inwardly gather and crumple a sheet stock material as it moves through an aperture between the grippers 242 and 244. This conversion machine 240 produces another type of dunnage product 246, one which has undulating crumpled lobes and is suitable for use as a void fill dunnage product.

Still another type of conversion machine 250 is shown in FIG. 27. This dunnage conversion machine includes upstream and downstream sets of rotating members 252 and 254. The downstream rotating members 254 feed the stock material therethrough at a slower rate than the rate at which the stock material is fed by the upstream rotating members 252. As a result, the stock material accumulates and longitudinally crumples therebetween before being passed through the downstream rotating members 254. This type of dunnage conversion machine 250 produces a relatively flatter dunnage product 256 that can be used as a protective wrap or for layered protection.

Other types of conversion mechanisms or other means for converting the sheet stock material into a relatively thicker and/or less dense dunnage product can be used in place of the illustrated conversion machines 230, 240, and 250.

For further details about dunnage conversion machines as shown or similar to the ones shown in FIGS. 25-27, reference may be had to U.S. Pat. Nos. 6,019,715; 6,277,459 and 6,676,589, each of which is hereby incorporated by reference. Still other types of dunnage conversion machines form plastic bags that are filled with air or foam to provide a packaging material.

To facilitate splicing a new supply of stock material, a splicing assembly (not shown) may be incorporated into or provided with the conversion mechanism.

The stock material passes over the splicing assembly as the stock material is fed into the conversion mechanism. The splicing assembly may include, for example, a transversely extending splice plate and one or more clamps mounted on opposite sides of the path of the stock material. One type of clamp is spring-biased against an adjacent clamping surface and is rotatable from a position clear of the stock material path to a position overlaying the stock material path, such that when released the clamps can hold the stock material to the clamping surface. If desired, magnets can be used as clamps.

The splicing plate provides a surface along which the stock material may be spliced. Thus, when the trailing end portion or portions of the almost-spent supply of stock material are held, the leading end portion or portions of the ply or plies of a succeeding or new supply of stock material may be spliced to the respective trailing end portion or portions. To detect that a supply of stock material is nearing its depleted or spent state, an end-of-web detector also may be provided. For further details concerning an exemplary splicing plate, reference may be had to commonly owned U.S. Pat. No. 5,755,656. For further details concerning the end-of-web detector, reference may be had to U.S. Pat. No. 5,749,821, which also is assigned to the assignee of the present invention. Both of these patents also are incorporated by reference.

Although the invention has been shown and described with respect to certain illustrated embodiments, equivalent alterations and modifications will occur to others skilled in the art upon reading and understanding the specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function (i.e., that is functionally equivalent), even though not structurally equivalent to the disclosed structure which performs the function in the herein illustrated embodiments of the invention. In addition, while a particular feature of the invention may have been described above with respect to only one of several illustrated embodiments, such a feature may be combined with one or more other features of the other embodiment, as maybe desired and advantageous for any given or particular application.

What is claimed is:

1. A dunnage conversion system comprising:
a fastening mechanism for mechanically fastening a leading portion of a succeeding supply of stock material to a trailing portion of a preceding supply of stock material, and
a conversion mechanism downstream of the fastening mechanism for converting the stock material into a relatively less dense dunnage product.

2. A system as set forth in claim 1 or any other claim, wherein the fastening mechanism provides one or more interlocking elements that mechanically interlock the leading and trailing portions.

3. A system as set forth in claim 2, wherein the interlocking elements are formed from the leading and trailing portions.

4. A system as set forth in claim 1 or any other claim, wherein the fastening mechanism includes one or more of a punch or an embossing mechanism.

5. A system as set forth in claim 1 or any other claim, wherein the fastening mechanism applies one or more connecting components to the leading portion and the trailing portion to effect a connection therebetween.

6. A system as set forth in claim 5, wherein the connecting components include one or more of stitches, staples, rivets, or clips.

7. A system as set forth in claim 1 or any other claim, wherein the fastening mechanism includes one or more of a stitching mechanism, a stapler, a riveter, or a clip applicator.

8. A system as set forth in claim 1 or any other claim, wherein the fastening mechanism applies at least one of at least two mateable fastening elements to at least one of the leading and the trailing end portions.

9. A system as set forth in claim 8, wherein the mateable fastening elements include at least one of: male and female interlocking devices, snaps, and hook and loop fasteners.

10. A system as set forth in claim 1 or any other claim, wherein the conversion mechanism includes a feed device that draws the stock material through a crumpling device.

11. A system as set forth in claim 1 or any other claim, wherein the fastening mechanism includes a device that applies respective portions of a hook-and-loop fastener to leading and trailing portions of the stock material to hold them together.

12. A method comprising the steps of
mechanically fastening a leading portion of a succeeding supply of stock material to a trailing portion of a preceding supply of stock material, and
converting the stock material into a relatively less dense dunnage product.

13. A method as set forth in claim 12 or any other claim, wherein fastening includes overlapping the leading and trailing portions.

14. A method as set forth in claim 12 or any other claim, wherein mechanically fastening includes providing interface elements that mechanically interlock the leading and trailing portions.

15. A method as set forth in claim 12 or any other claim, wherein fastening includes one or more of punching or embossing.

16. A method as set forth in claim 12 or any other claim, wherein fastening includes applying one or more connecting components to the leading and trailing portions to effect a connection therebetween.

17. A method as set forth in claim 12 or any other claim, wherein fastening includes stitching, stapling, riveting, or clipping the leading and trailing portions to effect a connection therebetween.

18. A supply of stock material for use in a dunnage converter for conversion into relatively less dense dunnage product, comprising a length of stock material having opposite leading and trailing end portions, and mateable fastening elements respectively attached to the leading and trailing portions of the stock material, whereby the mateable fastening elements can be attached to respective fastening elements of a succeeding or preceding supply of stock material before passage through the conversion mechanism.

19. A supply as set forth in claim 18, wherein the mateable fastening elements include snaps, and hook and loop fasteners.

20. A dunnage conversion system comprising
a device for activating a bonding agent on at least one of a leading portion of a succeeding supply of sheet stock material or a trailing portion of a preceding supply of sheet stock material to bond the leading and trailing portions together, and
a conversion mechanism downstream of the activating device for converting the stock material into a relatively less dense dunnage product.

21. A system as set forth in claim 20 or any other claim, including a supply of cohesive stock material with cohesive materials on the leading and trailing portions.

22. A method for preparing a stock material for conversion into a dunnage product, comprising the steps of
applying an activatable bonding material to at least one of a leading portion and a trailing portion of a supply of sheet stock material; and
either rolling the sheet stock material into a roll or fan-folding the sheet stock material to form a stack.

23. A method for producing a dunnage product, comprising the steps of:
providing a stock material with a bonding agent on at least a leading portion of a succeeding supply of stock material,
activating the bonding agent to bond the leading portion to a trailing portion of a preceding supply of stock material, and
converting the stock material into a relatively less dense dunnage product.

24. A method as set forth in claim 23 or any other claim, wherein the activating step includes applying at least one of heat, radiation, vibrations, or an electrical potential to the bonding agent.

25. A method as set forth in claim 23 or claim 24 or any other claim, wherein the converting step includes feeding the bonded leading and trailing portions through a conversion mechanism.

26. A method as set forth in any of claims 23 to 25 or any other claim, wherein the converting step includes crumpling a sheet stock material.

27. A dunnage conversion method comprising the steps of:
providing stock material from a first supply having a first part of a cohesive on a trailing portion,
converting the stock material from the first supply into a dunnage product,
providing stock material from a second supply having a second part of a cohesive on a leading portion, and
bonding the leading and trailing portions together.

28. A method as set forth in claim 27 or any other claim, wherein the bonding step includes overlapping the leading and trailing portions.

29. A dunnage conversion system comprising
a charging device for imparting opposing electrostatic charges to at least one of a leading portion of a succeeding supply of stock material or a trailing portion of a preceding supply of stock material to bond the leading and trailing portions together, and
a conversion mechanism downstream of the charging device for converting the stock material into a relatively less dense dunnage product.

30. A method for producing a dunnage product, comprising the steps of:
attaching a leading portion of a succeeding supply of stock material to a trailing portion of a preceding supply of stock material by means of an electromagnetic field or electrostatic charges, and
converting the stock material into a relatively less dense dunnage product.

31. A method as set forth in claim 30 or any other claim, wherein the attaching step includes integrating one or more elements into the stock material to provide a stock material with magnetic or magnetizable material in the leading or trailing portion.

32. A method as set forth in claim 29 or claim 30 or any other claim, wherein the attaching step includes imparting opposing and attractive magnetic charges in respective leading and trailing portions so that they are held together.

33. A method as set forth in any of claims 30-32 or any other claim, wherein the attaching step includes inducing an electrostatic charge or a magnetic field in at least one of the leading and trailing portions of the stock material.

34. A method as set forth in any of claims 30-33 or any other claim, wherein the converting step includes feeding the leading and trailing portions of the stock material through a crumpling device.

35. A method as set forth in any of claims 30-34 or any other claim, comprising the step of providing a sheet stock material.

36. A method as set forth in any of claims 30-35 or any other claim, wherein the attaching step includes overlapping the leading and trailing portions.

37. A method for producing a stock material for conversion into a dunnage product, comprising the step of providing a magnetic material at a leading or trailing portion of a length of sheet stock material.

38. A method as set forth in claim 37 or any other claim, wherein the providing step includes providing a stack of fan-folded sheet stock material or a roll of sheet stock material.
